(19) United States
(12) Patent Application Publication
(10) Pub. No.: US 2003/0107857 A1
(43) Pub. Date: Jun. 12, 2003

(54) Module with surge arrester for a high-voltage system

(76) Inventors: Harald Fien, Berlin (DE); Volker Hinrichsen, Darmstadt (DE)

Correspondence Address: MORRISON & FOERSTER LLP, 1650 TYSONS BOULEVARD, SUITE 300, MCLEAN, VA, 22102, US

(21) Appl. No.: 10/257,444

(22) PCT Filed: Mar. 6, 2001
(86) PCT No.: PCT/DE01/00937

(30) Foreign Application Priority Data
Apr. 14, 2000 (DE) 100201296

(51) Int. Cl. H02H 9/00

(52) U.S. Cl. 361/56

(57) ABSTRACT

The invention relates to a novel module that comprises an insulator (1) that forms an integral part with a surge arrester (2) composed of resistor elements. The insulator (1) is configured as a composite part with a solid body (12), for example a glass-fiber reinforced plastic tube, and an elastomer sleeve (13) molded thereonto, for example a protection, and the surge arrester (2) is embedded into the molded-on elastomer sleeve (13).

The invention lies in the field of basic electrical components and is to be applied in the constructive configuration of an insulator which is combined with an overvoltage arrester to form a module.

In the area of power transmission and distribution, metal oxide resistors based on zinc oxide with a highly non-linear characteristic have recently been used as overvoltage arresters. The relatively small structural volume of such arresters opens up the possibility of integrating such arresters into bushings, cable end terminations and also into the interior of transformers and switching systems (z “Bulletin SEV/VSE”, July 1998, pages 13 to 20). In the case of a known integration of an arrester of this type into a bushing for a high-voltage-carrying electrical conductor, the individual resistance elements of the arrester, which are stacked to form a column, are arranged within the insulator concentrically with respect to the axis thereof and thus also concentrically with respect to the high-voltage-carrying conductor. In this case, the insulator comprises a housing which is of hollow design and is provided with a shielding, and has a metal foot part and a metal head part. In this case, the arrester resistance elements arranged within the housing form individual sections of the wall of a hollow cylinder or of a truncated cone. On one of its ends, this cylinder or cone is placed onto contact parts which are led outward radially through the wall of the insulator; at its other end, the cylinder or the cone is connected to the high-voltage-carrying conductor (JP 59-207513A, JP 59-207514A). Such an assignment of the overvoltage arrester to the high-voltage insulator requires, in the foot region — which is at ground potential — of the arrester, a relatively large distance from the electrical conductor which is at high-voltage potential, and thus a large diameter of the insulator at least in the foot region. The contact-making devices required for making contact with the arrester likewise increase the volume and also the complexity of the module.

It is furthermore known to integrate an overvoltage arrester into a cable end termination or into a hollow post insulator — through which a drive rod penetrates — for a high-voltage circuit-breaker (EP 0 388 799 B1, DE 196 47 736 C1).

Proceeding from a module having the features of the preamble of patent claim 1, the invention is based on the object of providing the module with a simple construction and thus a more compact design.

In order to achieve this object, according to the invention it is provided that the insulator exists as a composite body with a solid body and an encapsulation made of an elastomer, said encapsulation being cast or injection-molded onto the body, and that the overvoltage arrester is embedded in the elastomer encapsulation. In the sense of the invention, the “insulator” is understood to mean both solid and hollow insulators and also synthetic resin insulating bodies (bushings) arranged around a conductor, in particular those used for voltage levels above 6 kV.

In the case of such a configuration of the module, the overvoltage arrester is not arranged within the solid body of the insulator, rather it is assigned to the insulator outside the solid body. As a result of the “backup” assignment provided, there is no need to alter the construction of the solid body and its dimensions, while the embedding into the potted or injection-molded elastomer encapsulation of the composite body can be realized in a relatively simple manner. This is true particularly when commercially available standard elements in the form of solid cylindrical or parallelepipedal bodies, which may, if appropriate, have a central hole for mounting purposes, are used as resistance elements of the arrester. Composite bodies with a solid body made of a glass-fiber-reinforced plastic tube or bar and with an elastomer encapsulation that is cast or injection-molded on are customary per se for high-voltage insulators. In this case, the elastomer encapsulation is quite generally designed as shielding.

The overvoltage arrester integrated into a composite body may comprise one or more, for example two or four, arrester columns constructed from resistance elements. In the case of two arrester columns it is recommended that the columns be arranged closely adjacent to one another or diagonally opposite one another with respect to the axis of the bushing insulator; in the case of three or more arrester columns it is recommended that the columns be divided into two groups and the two column groups be arranged diagonally opposite one another with respect to the axis of the insulator. Preferably, the arrester columns are arranged in a mirror-inverted manner with respect to a plane that takes up the axis of the insulator. In all these cases, the additional consumption of elastomer material that is associated with the thickening of the encapsulation of the insulator can be kept as small as possible. For this purpose, it is expedient if the outer contour of the wall of the elastomer encapsulation is adapted to the outer contour of the solid body and of the arrester column/s.

In the case of modules which the insulator is provided with a metal foot part and a metal head part, the mechanical retention of the arrester columns that is provided with the embedding of the arrester columns in the elastomer encapsulation that is cast on or injection-molded on can be improved in that the connection elements provided for electrically connecting the arrester columns to the foot part and the head part of the insulator are designed as mechanical carrying members. In this case, the connection elements may have the form of extended profile bodies or slender pins.

The insulator into whose elastomer encapsulation the overvoltage arrester is integrated can be utilized in various ways with its solid body. In the case of configuration as a hollow insulator, the internal space can accommodate an electrical component such as a bushing — with or without capacitor control —, a cable end provided with a field control or an end termination, or a voltage divider; however, a mechanical component such as a switching rod may also penetrate through it and it may perform a straightforward post insulator function.

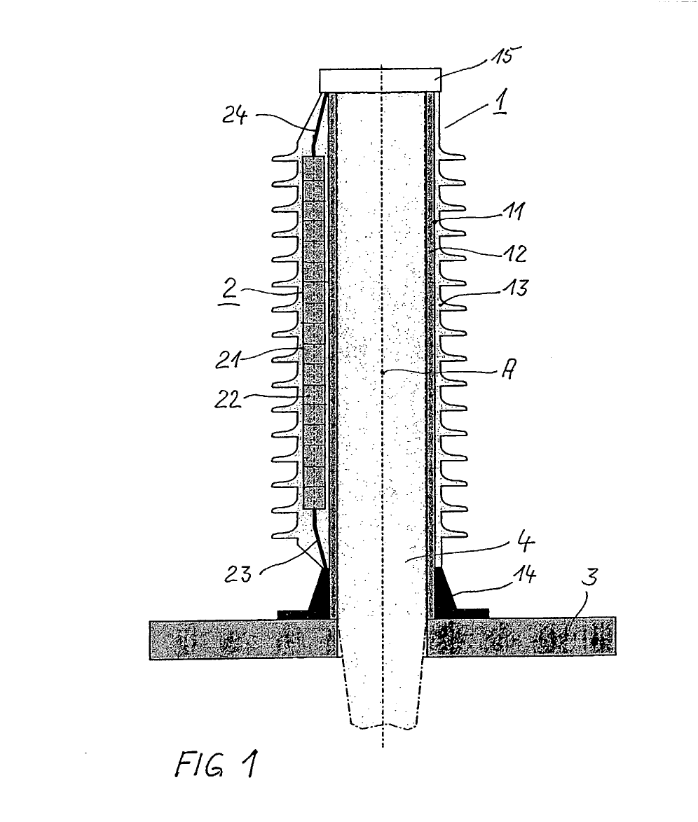

Exemplary embodiments of the invention are illustrated in FIGS. 1 to 5, in which:

FIG. 1 shows a module with an overvoltage arrester integrated into a potted silicon shielding of a hollow composite body, and

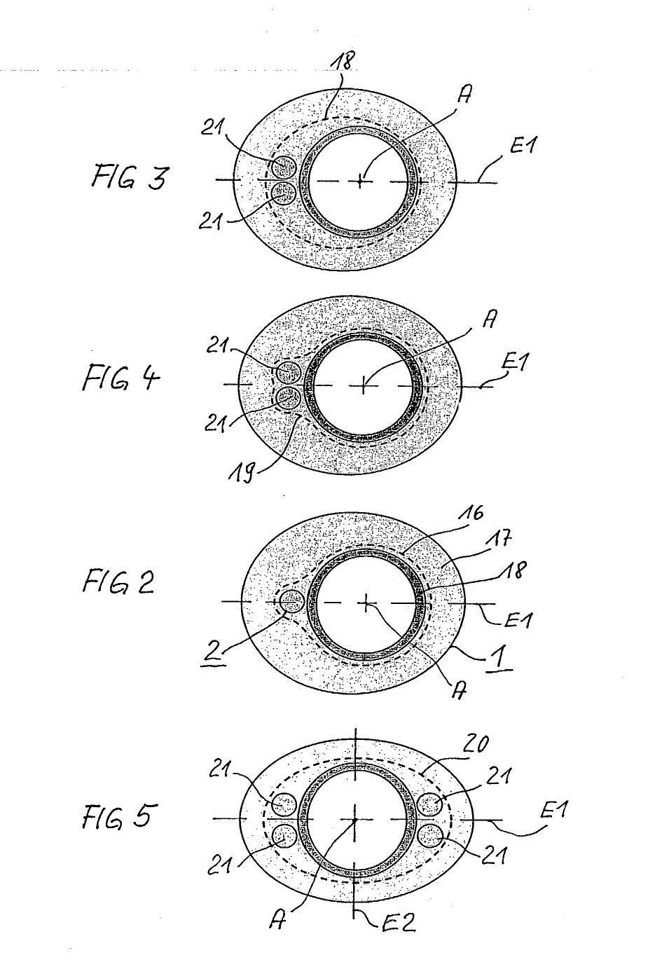

FIG. 2 shows a cross-sectional illustration with respect to FIG. 1.

FIGS. 3 to 5 show two variants with respect to FIG. 2 with regard to the arrangement of a plurality of arrester columns.

FIG. 1 shows a module which essentially comprises a tubular high-voltage insultator 1 and an overvoltage arrester 2 and is arranged on a circuit board 3. In its interior, the high-voltage insulator 1 contains an electrical component 4, which is a high-voltage bushing in. the form of an electrical conductor provided with a capacitor control.

The high-voltage insulator 1 of the module has a housing 11 comprising a glass-fiber-reinforced plastic tube 12 and also a shielding 13 made of an elastomer, said shielding being applied to said tube. The shielding 13 is dimensioned in such a way that the high-voltage insulator 1 is designed for a voltage level of 145 kV. The housing 11 is furthermore provided with a metal foot part 14 and a metal head part 15.

The overvoltage arrester 2 comprises a column 21 made of a plurality of resistance elements 22 and is electrically connected to the metal foot part 14 via a lower electrical connection 23 and to the metal head part 15 via an upper electrical connection element 24. The connection elements 23 and 24, which are only diagrammatically illustrated, are mechanical so stable that the arrester column 21 is reliably supported. Moreover, the arrester column 21 is completely embedded in the potting of the elastomer shielding 13.

In accordance with FIG. 2, the arrester column 21 is embedded in such a way that, given an oval contour of the shields 17, the actual wall 18 of the elastomer shielding 13 has a contour 16 which is adapted to the outer contour of the glass-fiber-reinforced plastic tube 12 and of the assigned arrester column 21 and thus has an essentially uniform wall thickness over the periphery of the glass-fiber-reinforced plastic tube.

In the case of the exemplary embodiment in accordance with FIG. 3, two arrester columns 21 are arranged mirror-symmetrically with respect to a plane E1 which takes up the axis A of the high-voltage insulator 1. In this case, with regard to the elastomer shielding, not only the shields 17 but also the wall 18 are provided with an outer oval contour.

In the case of the exemplary embodiment in accordance with FIG. 4, in a departure from FIG. 3, the contour 19 of the wall of the elastomer shielding is adapted to the outer contour of the glass-fiberre-inforced plastic tube 12 and of the two arrester columns 21.

In the case of the exemplary embodiment in accordance with FIG. 5, there are arranged a total of four arrester columns 21 which are combined to form two modules in such a way that the two modules are diagonally opposite one another with respect to the axis A of the high-voltage insulator and, at the same time, are arranged mirror-symmetrically both with respect to a plane E1 and with respect to a plane E2 which take up the axis A of the high-voltage insulator.

With the use of three arrester columns as module, the latter are expediently arranged in such a way that an arrester column in accordance with FIG. 2 is assigned in each case a further arrester column on both sides. A mirror-symmetrical arrangement with respect to the plane E1 is provided in this case, too.

Patent claims:

1. A module for a high-voltage system, comprising an insulator and an overvoltage arrester structurally combined with the insulator, the overvoltage arrester comprising at least one column of resistance elements, characterized
in that the insulator (11) exists as a composite body with a solid body (12) and an encapsulation (13) made of an elastomer, said encapsulation being cast or injection-molded onto the body,
and in that the overvoltage arrester (2) is embedded in the elastomer encapsulation (13).

2. The module as claimed in claim 1 having two or more arrester columns constructed from resistance elements, characterized
in that the arrester columns (21) are arranged mirror-symmetrically with respect to a plane (E1, E2) that takes up the axis (A) of the insulator (1).

3. The module as claimed in claim 1 or 2, characterized
in that the outer contour (16) of the wall (18) of the elastomer encapsulation is adapted to the outer contour of the solid body (12) and of the arrester column/s (21).

4. The module as claimed in one of claims 1 to 3, in which the insulator is provided with a metal foot part and a metal head part, characterized
in that the arrester column/s (21) are electrically connected to the foot part (14) and the head part (15) of the insulator (11) by means of connection elements (23, 24),
and in that the connection elements (14, 15) are designed as mechanical carrying members.

5. The module as claimed in one of claims 1 to 4, characterized
in that the composite body (11) is of hollow design and surrounds an electrical or a mechanical component (4).

6. The module as claimed in one of claims 1 to 5, characterized in that
the elastomer encapsulation (13) is designed as shielding.
